(19) United States
(12) Patent Application Publication
(10) Pub. No.: US 2008/0265663 A1
(43) Pub. Date: Oct. 30, 2008

(54) Active Brake Pads Retraction System and Method

(75) Inventors: Chris A. G. Leach, Bowmanville (CA); Terry W. Ostan, Whitby (CA)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/739,721

(22) Filed: Apr. 25, 2007

(51) Int. Cl. B60T 8/32; B60T 13/10

(52) U.S. Cl. 303/10; 303/113.1; 477/185

(57) ABSTRACT

Brake pads are retracted with respect to the brake rotor responsive to predetermined conditions of the motor vehicle in which braking is not required. Selective application of negative brake line pressure causes the caliper pistons to retract with respect to their respective caliper cylinders, thereby causing the brake pads to retract from the brake rotor. The predetermined conditions of the motor vehicle when braking is not required include when the motor vehicle is cruising or is parked.

### TECHNICAL FIELD

The present invention relates to braking systems used in motor vehicles. More particularly, the present invention relates to a system and method of actively retracting brake pads from brake rotors during predetermined conditions of the motor vehicle.

### BACKGROUND OF THE INVENTION

Motor vehicle disk brake systems utilize, at each wheel, a brake rotor connected to an axle hub of a rotatable axle of the motor vehicle, and an opposing set of selectively movable brake pads connected to a non-rotating brake caliper which carries a set of brake pads. The brake rotor includes a disk-shaped rotor cheek having opposing brake pad engagement surfaces, wherein when braking is to occur, the braking system causes the caliper to press the brake pads upon respective brake pad engagement surfaces of the rotor cheek. Frictional interaction between the rotating rotor cheek and non-rotating brake pads causes braking of the motor vehicle to transpire, the rate of braking depending upon the pressure of the brake pads against the rotor cheek.

In the automotive art, modern dual-circuit hydraulic braking systems for automotive applications typically include an operator-actuated brake actuation unit, such as a tandem master cylinder actuated by a booster-aided brake pedal, by which to supply a first pressurized brake fluid to each of a first pair of wheel brakes via a first or “primary” braking circuit, and a second pressurized brake fluid to each of a second pair of wheel brakes via a second or “secondary” braking circuit. The use of wholly redundant braking circuits for operating discrete pairs of wheel brakes ensures continued vehicle braking capability, notwithstanding a degradation of performance of one of the braking circuits.

In order to achieve an “anti-lock” braking system (ABS), each braking circuit often features a normally-open electrically-operated inlet valve controlling the flow of pressurized fluid to each wheel brake, while a pressure relief line that includes a normally-closed electrically-operated outlet valve, a return pump, and a check valve controls the return of pressurized fluid from the wheel brake to the hydraulic brake line upstream of the inlet valve. A “separation” or “isolation” valve, located in the hydraulic brake line of each circuit upstream of the location at which the pressure relief line connects to the brake line, serves to isolate the brake line from the master cylinder during anti-lock operation.

Increasingly, such anti-lock braking systems are used in combination with wheel speed sensors in a traction control mode. The further addition of a steering angle sensor, a vehicle yaw rate sensor, and a lateral vehicle acceleration sensor in conjunction with vehicle speed, wheel speed, and wheel longitudinal slip enables such anti-lock braking systems to operate in an “electronic stability control” mode, wherein a braking system electronic control unit (ECU) selectively energizes each circuit's electrically-operated valves when the controller identifies an opportunity to enhance vehicle stability through a selective application of the vehicle's brakes.

In order to control the brake fluid pressure in traction control or vehicle stability control modes, an hydraulic pump is typically placed in the pressure relief line of each circuit downstream of the outlet valve to return pressurized fluid to the circuit's hydraulic brake line. The pump also serves to provide an increasing rate of fluid pressure upon the closing of the isolation valve to provide a sufficient braking system response time when operating in a traction control mode, even at a time when the brake fluid has a relatively-high viscosity due, for example, to low brake fluid temperatures.

The prior art has recognized, however, that a quicker system response is desirable when the braking system is operated in a vehicle stability control mode. By way of example, a rapid pressure build up in one or the other braking circuit is particularly desirable upon commencing vehicle stability control in order to correct oversteer or understeer conditions. Accordingly, the prior art teaches the addition of a braking circuit pre-charging function to the brake actuation unit, i.e., to the vacuum booster of the master cylinder, in order to increase system response at the time such vehicle stability control is commenced. Alternatively, an additional pre-charging pump is provided in one or both braking circuits to ensure a sufficient increasing rate of fluid pressure at the commencement of vehicle stability control enhancement.

There are multiple Electronic Stability Control (ESC) system implementations on the road today. Although all of them attempt to perform the same task of helping the driver retain reasonable directional control under nonlinear vehicle dynamic conditions, these ESC systems have some distinct implementation differences and can be divided into four categories as defined and described in The Society of Automotive Engineers (SAE) Surface Vehicle Information Report, SAE J2564, “Automotive Stability Enhancement Systems”, revised June, 2004 and superceding version issued December, 2000.

Elements that ESC systems have in common include ABS and the ability to sense steering wheel position; the ability to calculate vehicle speed; the ability to sense yaw velocity and lateral acceleration; and the ability to build and control braking force in the channels used for yaw stability control independent of the driver's input to the vehicle braking system. An example of the implementation of a vehicle hydraulic braking system utilizing an ESC system is described in U.S. Pat. No. 6,896,338 B2 to Nakayasu et al., which patent is hereby incorporated herein by reference in its entirety.

Referring now to FIGS. 1A and 1B, the structural and operational aspects of a prior art anti-lock braking system (ABS) will be described, keeping the description limited to those portions thereof having relevance to the present invention.

An ABS 10 includes an electronic control unit (ECU) 12 which is electronically interfaced with a brake pedal assembly 14, at least one hydraulic brake fluid pump 16, and at each wheel with an inlet valve 18, and an outlet valve 20. An hydraulic brake line 22 is interfaced with the brake fluid pump and the inlet and outlet valves at each wheel, and is further interfaced with a master cylinder brake fluid reservoir 24, and still further interfaced at each brake corner (i.e., at each vehicle wheel) with caliper actuators 26 (consisting of one or more cylinders 26a and pistons 26b). A brake caliper 28 is non-rotatively affixed at each wheel in straddling relation to the brake rotor 30 of the respective brake corner (which is, in turn, connected in fixed relation to the rotative wheel axle (not shown). In a braking system utilizing a sliding brake caliper (as is shown in FIGS. 1A and 1B), one side 28a of the brake caliper is hydraulically active and the other side 28b hydraulically inactive. In a braking system utilizing a fixed brake caliper, both sides of the brake caliper are hydraulically active. In either case, a brake pad 32a, 32b is respectively affixed at both sides of the brake caliper, so that when the hydraulic brake fluid in the caliper portion 22a of the brake line 22 is pressurized, the brake caliper causes the brake pads to squeeze upon the cheeks 30a of the brake rotor 30.

In operation, the ECU constantly runs predetermined algorithms while receiving vehicular behavior inputs (via sensors) to determine brake action commands. In FIG. 1A, a brake apply situation is occurring. The ECU has commanded the inlet valve be open, the outlet valve be closed and the brake fluid pump to rapidly energize so as to provide a high pressure HP brake fluid in the caliper portion of the brake line, thereby applying the brakes in the sense that the brake pads press hard against the rotor cheeks. The normally open inlet valve and normally closed outlet valve are such during normal braking, being selectively opened and closed by the ECU during an ABS event, as for example when slip at the wheels is occurring. In FIG. 1B, a no brake apply situation is occurring. The ECU has commanded the inlet valve to remain open, the outlet valve to remain closed and the brake fluid pump to de-energize so as to provide a low pressure LP brake fluid in the caliper portion of the hydraulic brake line, thereby releasing the brakes in the sense that the brake pads no longer press hard against the rotor cheeks.

The focus of current braking system design is on rapid response to reduce vehicle stopping distance and on high pressure sealing to ensure hydraulic brake system integrity. These design targets typically require a sealing implementation in which the brake pads are unable to actively retract from the brake rotor after brake application, since the response of the braking system is optimized for quick response and high sealing ability.

In this regard, the application of the brake pads to the rotor flexes the seals of the hydraulic braking system. Since the braking system is designed for quick response and sealing of high hydraulic pressures, the seals do not fully return the braking system back to zero pressure, and the brake pads remain in adjacency with the brake rotor cheeks even when the brake pedal is not pressed by the vehicle operator. Thus, the brake pad material is kept in close contact to the rotor cheeks in all conditions of the motor vehicle.

This close contact of the brake pads with the brake rotor during brake rotor rotation creates a frictional force due to the residual force of the seal (from the last brake application) which, in turn, creates a torque in the opposite direction of vehicle's forward rotation. This torque, termed drag torque, reduces the efficiency of the vehicle's propulsion system and thereby increases fuel consumption. When the vehicle is parked, this same residual force from the seals keeps the brake pad material in contact with the brake rotor cheeks. When these components, which are typically manufactured with a percentage of metal, are exposed to moisture, they can corrode via galvanic action. This galvanic action creates inconsistencies on the rotor cheeks and brake pad surfaces locally on the section of the brake rotor where these components were in mutual contact. These surface inconsistencies create a local rotor cheek thickness and surface material property mix different than the rest of the rotor cheeks. This physically unique section of the brake rotor creates a different frictional force compared to the rest of the brake rotor during rotation when the brakes are applied. This varying frictional force creates a periodically varying frictional torque, the period coinciding with the rate of rotation. This variable torque excites the brake caliper which, in turn, excites the suspension components of the vehicle, and this resultant vibration is sensed by the vehicle's operator through the steering wheel and the body, and is also sensed as pulsation of the brake pedal. The vehicle operator can perceive this condition as annoying and may seek early brake servicing.

Accordingly, what remains needed in the art is a brake system in which the brake pads are actively retracted (separated) from the brake rotor cheeks during predetermined conditions of the motor vehicle.

### SUMMARY OF THE INVENTION

The present invention is an active brake pad retraction system which retracts the brake pads with respect to the brake rotor responsive to predetermined conditions of the motor vehicle in which braking is not required. To accomplish this benefit, the present invention utilizes selective application of negative hydraulic brake line pressure to cause the caliper pistons to retract with respect to their respective caliper cylinders, thereby causing the brake pads to retract from the brake rotor (i.e., the brake pads are affirmatively relocated by the brake line vacuum differential pressure with respect to atmospheric into a spaced relation with respect to the rotor cheeks.

The active brake pad retraction system according to the present invention utilizes the electronic and hydraulic brake control system utilized by current anti-lock brake systems (ABS), wherein these control systems are uniquely configured to provide active retraction of the brake pads from the brake rotor during predetermined conditions of the motor vehicle when braking is not required, as for example when the motor vehicle is cruising or parked.

In operation, the electronic control unit (ECU) of the ABS constantly runs algorithms, including an active brake pad retraction algorithm, while receiving vehicular behavior inputs to determine brake action commands. Upon command from the ECU to execute active brake pad retraction, the normally open inlet valve of the hydraulic brake line is closed and the normally closed outlet valve of the brake line is opened. These valve settings isolate the caliper portion of the brake line from the pressure side, and simultaneously expose it to the vacuum side, of the hydraulic brake fluid pump. The brake fluid pump is thereupon immediately energized, pushing the hydraulic brake fluid in the brake line upstream of the brake fluid pump towards the master cylinder reservoir, which is vented to atmosphere. The brake line downstream of the brake fluid pump is therefore exposed to a negative (i.e., below atmospheric) brake line pressure. This negative pressure with respect to atmospheric pressure applies a suction-retraction force to the caliper portion of the brake line. This pressure differential is registered at the caliper pistons, which are caused to be pulled in the direction of the negative pressure to compensate for the displacement of the brake fluid pumped into the master cylinder brake fluid reservoir on the pressure side of the brake fluid pump. This displacement of the caliper pistons actively moves the brake pads, which are affixed to the pistons, as for example via brake pad clips known in the art, away from the rotor cheek surfaces.

In a braking system utilizing a sliding brake caliper, one side of the brake caliper is hydraulically active and the other side is hydraulically inactive, wherein the hydraulically active side brake pad tends to retract first until the brake caliper reacts to allow the hydraulically inactive side brake pad to also retract. In a braking system utilizing a fixed brake caliper, both sides of the brake caliper are hydraulically active and the caliper pistons retract independently of each other as both are directly affected by the negative pressure in the caliper portion of the brake line. In either type of brake caliper, brake pad retraction creates a gap between the brake pads and the brake rotor, thereby reducing parasitic brake drag and galvanic corrosion.

Accordingly, it is an object of the present invention to provide an active brake pad retraction system which retracts the brake pads with respect to the brake rotor responsive to predetermined conditions of the motor vehicle in which braking is not required.

This and additional objects, features and advantages of the present invention will become clearer from the following specification of a preferred embodiment.

### BRIEF DESCRIPTION OF THE DRAWINGS

FIG. 1A is a schematic depiction of a prior art anti-lock brake system (ABS), depicting a brakes applied situation, wherein the electronics and hydraulics for one brake corner are depicted.

FIG. 1B is a schematic depiction of the prior art ABS of FIG. 1A, now depicting a brakes un-applied situation.

FIG. 2 is a schematic depiction of an ABS incorporating an active brake pad retraction system according to the present invention, depicting a brakes un-applied situation in which an active brake pad retraction algorithm according to the present invention is implemented, wherein a sliding brake caliper is shown and wherein the hydraulics and electronics are with respect to one brake corner.

FIG. 3 is a schematic depiction of an ABS incorporating an active brake pad retraction system according to the present invention depicting a brakes un-applied situation in which the active brake pad retraction algorithm according to the present invention is implemented, wherein a fixed brake caliper is shown and wherein the hydraulics and electronics are with respect to one brake corner.

FIG. 4A is a partly sectional view of the brake caliper of FIG. 2, showing in particular a brake pad clips interface with the caliper pistons at the hydraulically active side of the brake caliper.

FIG. 4B is a partly sectional view of the brake caliper of FIG. 2, showing in particular a brake pad clips interface with the hydraulically inactive side of the brake caliper.

FIG. 5 is a graph showing negative pressure in the caliper portion of the hydraulic brake line versus caliper piston displacement for a test brake caliper.

FIG. 6 is a flow chart of an example of an active brake pad retraction algorithm for carrying out the steps of a method for implementing the active brake pad retraction system according to the present invention.

### DESCRIPTION OF THE PREFERRED EMBODIMENT

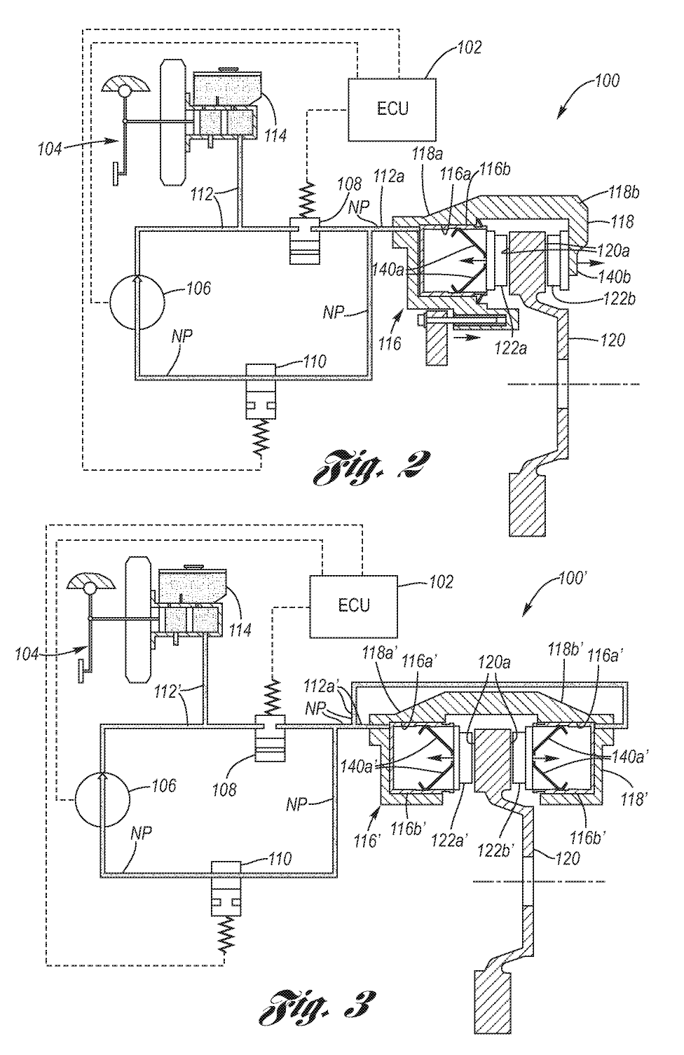

Referring now to the Drawing, FIGS. 2 through 6 depict various aspects of an example of an active brake pad retraction system according to the present invention.

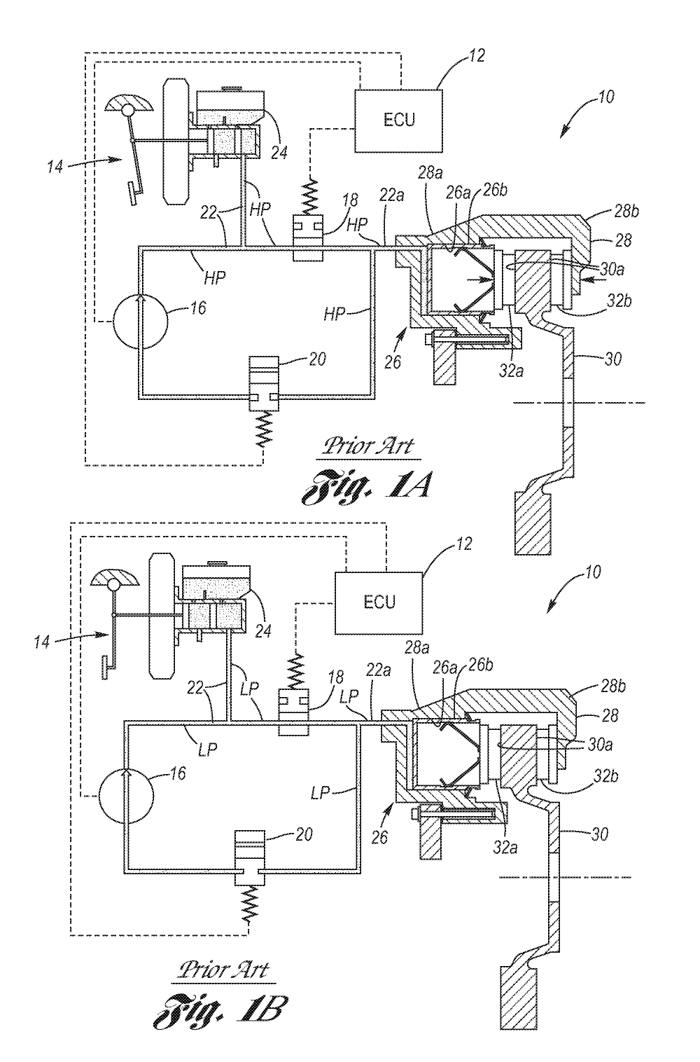

Referring firstly to FIGS. 2 and 3, an anti-lock brake system (ABS) 100, 100′ is generally similar to that referred to in FIGS. 1A and 1B, and includes an electronic control unit (ECU) 102 which is electronically interfaced with a brake pedal assembly 104, at least one hydraulic brake fluid pump 106 (i.e., there may be one pump or there may be, for example, two pumps, one for each brake circuit of the brake line), and at each brake corner with an inlet valve 108, and an outlet valve 110. An hydraulic brake line 112, 112′ is interfaced with the at least one brake fluid pump and the inlet and outlet valves at each wheel, and is further interfaced with a master cylinder brake fluid reservoir 114, and still further interfaced at each brake corner with caliper actuators 116, 116′ (consisting of one or more cylinders 116a, 116a′ and pistons 116b, 116b′). A brake caliper 118, 118′ is non-rotatively affixed at each brake corner (i.e., at each wheel) in straddling relation to the brake rotor 120 of the respective brake corner (which is, in turn, connected in fixed relation to the rotative wheel axle (not shown).

In a braking system 100 utilizing a sliding caliper 118 as is shown in FIG. 2, one side 118a of the caliper housing is hydraulically active and the other side 118b hydraulically inactive. In a braking system 100′ utilizing a fixed caliper 118′ as is shown at FIG. 3, both sides 118a′, 118b′ of the caliper housing are hydraulically active. With respect to application of the brakes, for either type of brake caliper 118, 118′, a brake pad 122a, 122a′, 122b, 122b′ is respectively affixed at both sides of the brake caliper, so that when the hydraulic brake fluid in the caliper portion 112a, 112a′ of the brake line is pressurized, the brake caliper causes the brake pads to squeeze upon the cheeks 120a of the brake rotor 120.

In operation, the ECU constantly runs predetermined algorithms, including an active brake pad retraction algorithm, as for example the active brake pad retraction algorithm 200 as shown at FIG. 6, while receiving vehicular behavior inputs to determine brake action commands. A brake apply situation is handled as generally shown and described with respect to FIG. 1A via a high pressure brake fluid at the caliper portion of the brake line. In a brake un-apply situation in which braking may be needed imminently, the situation is handled as generally shown and described with respect to FIG. 1B via a low pressure brake fluid at the caliper portion of the brake line. However, in a brake un-apply situation in which braking will not be needed, the ECU handles the situation differently from the scenario of FIG. 1B, as shown at FIGS. 2 and 3, via a negative pressure NP brake fluid at the caliper portion of the brake line according to an active brake pad retraction algorithm, as for example the active brake pad retraction algorithm 200 of FIG. 6 discussed in detail hereinbelow. The active brake pad retraction method proceeds as follows.

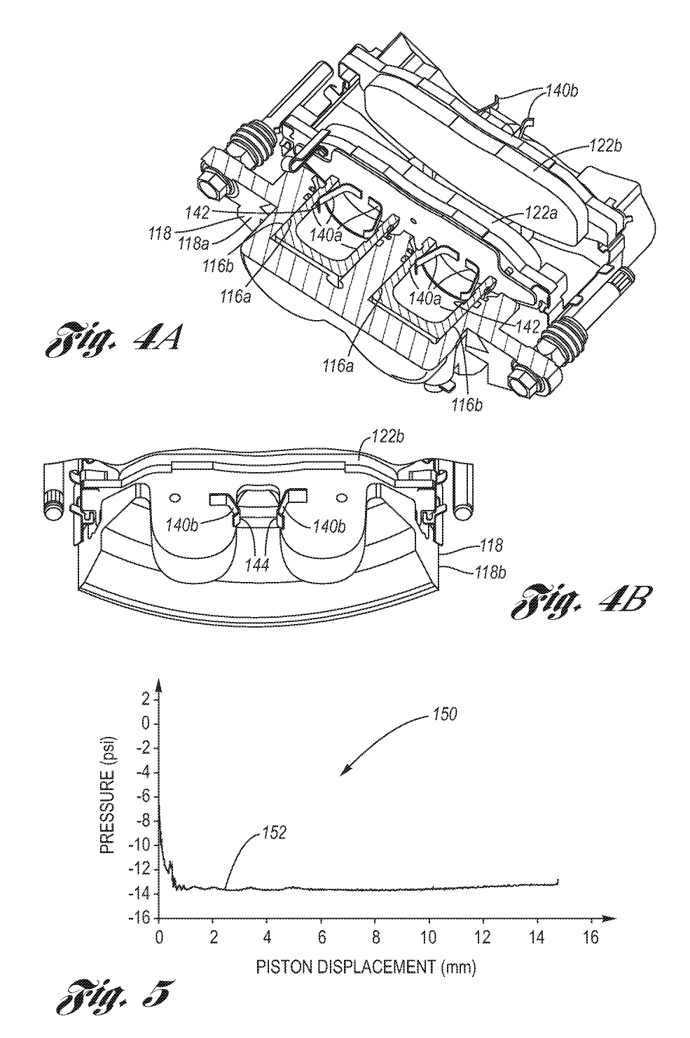

Upon command from the ECU 102 to execute active brake pad retraction, at each brake corner the normally open inlet valve 108 of the brake line 112, 112′ is closed and the normally closed outlet valve 110 of the brake line is opened. These valve settings, at each brake corner, isolate the caliper portion 112a, 112a′ of the brake line from the pressure side, and simultaneously expose it to the vacuum side, of the (at least one) brake fluid pump 106. The brake fluid pump is thereupon immediately energized, pushing the brake fluid in the brake line upstream of the brake fluid pump towards the master cylinder brake fluid reservoir 114, which is vented to atmosphere. The brake line (at each brake corner) downstream of the brake fluid pump is therefore exposed to a negative (i.e., below atmospheric) brake line pressure NP. This negative pressure NP of the brake fluid with respect to atmospheric pressure applies a suction-retraction force to the caliper portion of the brake line. This pressure differential is registered at the caliper pistons 116b, 116b′ (at each brake corner), which are caused to be pulled in the direction of the negative pressure to compensate for the displacement of brake fluid pumped into the master cylinder brake fluid reservoir on the pressure side of the brake fluid pump. This displacement of the caliper pistons moves the brake pads (at each brake corner), which are affixed to the caliper pistons, as for example via brake pad clips 140a, 140a′, 140b as generally known in the art (i.e., see FIGS. 1A and 1B), away from the rotor cheek surfaces. In this regard with respect to brake rotor 118 of FIG. 2, FIG. 4A shows that the brake pad clips 140a are each affixed to the active side of the brake pad 122a and resiliently clip onto an interior annular slot 142 of the caliper pistons 116b; and FIG. 4B shows that the brake pad clips 140b each are affixed to the inactive side of the brake pad 122b and resiliently clip onto an interior annular slot 144 of hydraulically inactive side 118b of the brake caliper.

In a brake system 100 utilizing a sliding brake caliper 118 (FIG. 2), since one side 118a of the caliper housing is hydraulically active and the other side is hydraulically inactive, the brake pad of the hydraulically active side tends to retract first until the brake caliper reacts to allow the hydraulically inactive side 118b and its brake pad to also retract. In a braking system 100′ utilizing a fixed brake caliper 118′ (FIG. 3), both sides 118a′, 118b′ of the caliper are hydraulically active and the caliper pistons retract independently of each other as both are directly affected by the negative pressure in the caliper portion of the brake line. With respect to active brake pad retraction, for either type of brake caliper 118, 118′, brake pad retraction creates a gap between the brake pads and the brake rotor, thereby reducing parasitic brake drag and galvanic corrosion.

In the event sensed vehicle conditions no longer indicate that the brakes will not be required, the ECU, pursuant to the active brake pad retraction algorithm, thereupon sends commands to close the outlet valve, open the inlet valve and activate the brake fluid pump, whereupon a low positive pressure in the brake fluid is experienced at the caliper portion of the brake line (at each brake corner), whereby the brake pads move toward the brake rotors a minimum allowable extent without actual brake application, in anticipation of future brake application. The commands may include implementation of a pre-charging feature of the braking system.

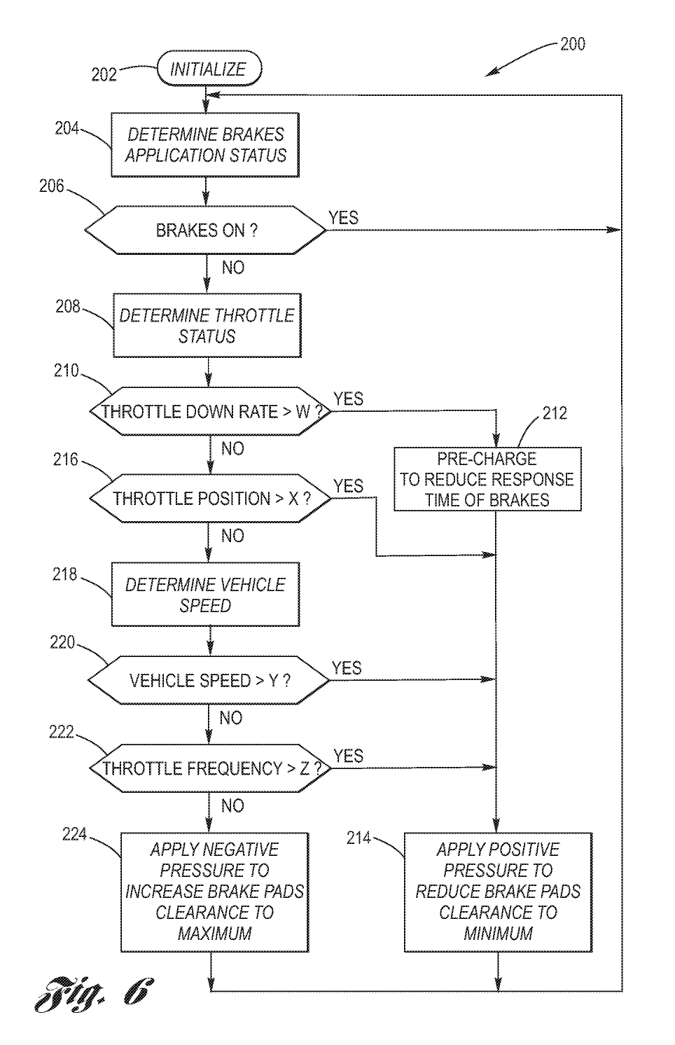

FIG. 5 is a graph 150 which shows a plot 152 of caliper piston displacement versus negative pressure in the caliper portion of the brake fluid line. It is seen from plot 152, that the differential pressure between atmospheric pressure and the indicated negative pressure in the caliper portion of the brake fluid line is capable of retraction of the brake pads from the brake rotor cheeks, per the description herein of the present invention.

Referring now to FIG. 6, depicted is a flow chart of an active brake pad retraction algorithm 200 indicating exemplar method steps for active brake pads retraction according to the present invention.

At Block 202 the algorithm is initialized. At Block 204, determination is made via one or more appropriate sensors, as for example a brake pedal position sensor, as to the current status of application of the brakes. The algorithm then advances to Decision Block 206.

At Decision Block 206, inquiry is made whether the brakes are applied. If the answer to the inquiry is yes, then the algorithm returns to Block 204 and awaits a change in brake application status. However, if the answer to the inquiry at Decision Block 206 is no, then the algorithm advances to Block 208. At Block 208, a determination of the status of the throttle is made via one or more appropriate sensors, as for example an accelerator pedal position sensor or a throttle position sensor.

The algorithm then advances to Decision Block 210, whereat inquiry is made whether the rate of throttle down (i.e., throttle un-apply) is greater than a predetermined threshold, W. The threshold, W, is predetermined by empirical testing for a particular motor vehicle; by way of exemplification, a preferred value for W may be about 450 degrees per second. If the answer to the inquiry is yes, then the algorithm advances to Block 214; however, if a brake pre-charge system is present in the brake system, then it is preferred to include advancement to Block 212 with the advancement to Block 214 (the advancement to Blocks 212 and 214 may be in series in either order or in parallel, a series advancement of order Blocks 212 then 214 being shown by way of example).

At Block 212, a quicker brake system response to an anticipated applied brake situation is provided by a rapid pressure build up in the brake lines via a pre-charging function of a brake actuation unit, i.e., to the vacuum booster of the master cylinder, in order to increase brake system response time via, for example, an additional pre-charging pump, as is well known in the art, as for example discussed hereinabove in paragraph [0007], to provide.

At Block 214, the algorithm directs the ECU to execute the following commands: close the outlet valve, open the inlet valve and activate the brake fluid pump, whereupon a low positive pressure in the brake fluid is experienced at the caliper portion of the brake line (at each brake corner), whereby the brake pads move toward the brake rotors a minimum allowable extent without actual brake application. The algorithm then returns to Block 204 for further processing as described. However, if the answer to the inquiry at Decision Block 210 is no, then the algorithm advances to Decision Block 216.

At Decision Block 216, inquiry is made whether the throttle position is greater than a predetermined threshold, X. The threshold, X, is predetermined by empirical testing for a particular motor vehicle; by way of exemplification, a preferred value for X may be about 30%. If the answer to the inquiry is yes, then the algorithm advances to Block 214, whereat the algorithm direct the ECU to execute the following commands: close the outlet valve, open the inlet valve and activate the brake fluid pump, whereupon a low positive pressure in the brake fluid is experienced at the caliper portion of the brake line (at each brake corner), whereby the brake pads move toward the brake rotors a minimum allowable extent without actual brake application. The algorithm then returns to Block 204 for further processing as described. However, if the answer to the inquiry at Decision Block 216 is no, then the algorithm advances to Block 218.

At Block 218, vehicle speed is determined via one or more appropriate sensors, as for example the speedometer sensor. The algorithm then advances to Decision Block 220, whereat inquiry is made whether the vehicle speed is greater than a predetermined threshold, Y. The threshold, Y, is predetermined by empirical testing for a particular motor vehicle; by way of exemplification, a preferred value for Y may be about 85 miles per hour, or about 130 kilometers per hour. If the answer to the inquiry is yes, then the algorithm advances to Block 214, whereat the algorithm directs the ECU to execute the following commands: close the outlet valve, open the inlet valve and activate the brake fluid pump, whereupon a low positive pressure in the brake fluid is experienced at the caliper portion of the brake line (at each brake corner), whereby the brake pads move toward the brake rotors a minimum allowable extent without actual brake application. The algorithm then returns to Block 204 for further processing as described. However, if the answer to the inquiry at Decision Block 220 is no, then the algorithm advances to Decision Block 222.

At Decision Block 222, inquiry is made whether the throttle frequency (that is the repetitive pressing per unit time of the accelerator pedal by the driver of the vehicle) is greater than a predetermined threshold, Z. The threshold, Z, is predetermined by empirical testing for a particular motor vehicle; by way of exemplification, a preferred value for Z may be about 1 Hz during a 10 second interval (that is, a throttle action (i.e., an application of the accelerator pedal) once each second over a time interval of 10 seconds). If the answer to the inquiry is yes, then the algorithm advances to Block 214, whereat the algorithm directs the ECU to execute the following commands: close the outlet valve, open the inlet valve and activate the brake fluid pump, whereupon a low positive pressure in the brake fluid is experienced at the caliper portion of the brake line (at each brake corner), whereby the brake pads move toward the brake rotors a minimum allowable extent without actual brake application. The algorithm then returns to Block 204 for further processing as described. However, if the answer to the inquiry at Decision Block 222 is no, then the algorithm advances to Block 224.

At Block 224, the algorithm directs the ECU to execute the following commands: open the outlet valve, close the inlet valve and activate the brake fluid pump, whereupon a negative pressure in the brake fluid is experienced at the caliper portion of the brake line (at each brake corner), whereby the brake pads move away from the brake rotors a maximum allowable extent so that there is no contact therebetween. The algorithm then returns to Block 204 for further processing as described.

To those skilled in the art to which this invention appertains, the above described preferred embodiment may be subject to change or modification. Such change or modification can be carried out without departing from the scope of the invention, which is intended to be limited only by the scope of the appended claims.

1. A braking system of a motor vehicle, comprising:
an hydraulic brake line having a pressurizable brake fluid therewithin; and
at least one brake corner, each brake corner comprising:
a brake caliper connected to said brake line; and
a pair of brake pads connected with said brake caliper in oppositely disposed relation to each other;
wherein when said brake fluid is pressurized below atmospheric pressure, said brake caliper responsively retracts said brake pads away from each other.

2. The braking system of claim 1, wherein the pressure of said brake fluid below atmospheric pressure is substantially between zero pounds per square inch and fourteen pounds per square inch below atmospheric pressure, and wherein the retraction is responsive to the brake fluid pressure and ranges between substantially zero millimeters and fourteen millimeters.

3. The braking system of claim 1, further comprising:
at least one hydraulic brake fluid pump operatively connected to said brake line; and
wherein each brake corner further comprises:
a normally open inlet valve connected to said brake line; and
a normally closed outlet valve connected to said brake line;
wherein said brake fluid is pressurized below atmospheric pressure in response to said inlet valve being closed, said outlet valve being open, and said at least one brake fluid pump being actuated.

4. The braking system of claim 3, further comprising:
a brake rotor disposed, respectively, at each said brake corner, wherein each said brake rotor comprises a pair of rotor cheeks disposed between said pair of brake pads at the respective brake corner;
wherein at each brake corner, when said brake pads retract with respect to each other in said response to said brake line pressure being below atmospheric pressure, said brake pads retract with respect to said rotor cheeks.

5. The braking system of claim 4, wherein the pressure of said brake fluid below atmospheric pressure is substantially between zero pounds per square inch and fourteen pounds per square inch below atmospheric pressure, and wherein the retraction is responsive to the brake fluid pressure and ranges between substantially zero millimeters and fourteen millimeters.

6. A method for retracting brake pads at each brake corner of a motor vehicle, comprising the steps of:
determining predetermined conditions of the motor vehicle, wherein the predetermined conditions comprise a determination whether the brakes are applied and whether braking is not required;
applying negative pressure with respect to atmospheric pressure to a brake line of the motor vehicle if said step of determining determines that the brakes are not applied and braking is not required; and
retracting the brake pads in response to said step of applying negative pressure.

7. The method of claim 6, wherein said step of determining predetermined conditions further comprises:
determining a rate of throttle down, wherein if the rate of throttle down is above a predetermined throttle down threshold, then the determination is that braking is other than not required.

8. The method of claim 7, wherein said step of determining predetermined conditions further comprises:
determining throttle position, wherein if the throttle position is above a predetermined throttle position threshold, then the determination is that braking is other than not required.

9. The method of claim 8, wherein said step of determining predetermined conditions further comprises:
determining vehicle speed, wherein if the vehicle speed is above a predetermined vehicle speed threshold, then the determination is that braking is other than not required.

10. The method of claim 9, wherein said step of determining predetermined conditions further comprises:
determining a throttle frequency, wherein if the throttle frequency is above a predetermined throttle frequency threshold, then the determination is that braking is other than not required.

11. The method of claim 10, wherein in said step of determining, if said predetermined conditions comprise the brakes are not applied, the rate of throttle down is not above the predetermined throttle down threshold, the throttle position is not above the predetermined throttle position threshold, the vehicle speed is not above the predetermined vehicle speed threshold, and the throttle frequency is not above the predetermined throttle frequency threshold, then the determination is that braking is not required.

12. The method of claim 11, wherein in said step of determining, the throttle down threshold is in a range substantially around 450 degrees per second; the throttle position threshold is in a range substantially around thirty percent; the vehicle speed threshold is in a range substantially around one hundred thirty kilometers per hour; and the throttle frequency threshold is in a range substantially around one throttle action per second over a ten second interval.

13. A method for operating a braking system of a motor vehicle, comprising the steps of:
determining predetermined conditions of the motor vehicle, wherein the predetermined conditions comprise a determination whether brakes are applied and whether braking is not required;
applying negative pressure to a brake line of the motor vehicle if said step of determining determines that the brakes are not applied and braking is not required, wherein brake pads of the braking system retract in response to said step of applying negative pressure; and
applying positive pressure to the brake line of the motor vehicle if said step of determining determines that the brakes are not applied and that braking is other than not required, wherein brake pads of the braking system are not retracted.

14. The method of claim 13, wherein said step of determining predetermined conditions further comprises:
determining a rate of throttle down, wherein if the rate of throttle down is above a predetermined throttle down threshold, then the determination is that braking is other than not required.

15. The method of claim 14, further comprising the step of pre-charging the braking system if said step of determining determines that the brakes are not applied and that braking is other than not required.

16. The method of claim 14, wherein said step of determining predetermined conditions further comprises:
determining throttle position, wherein if the throttle position is above a predetermined throttle position threshold, then the determination is that braking is other than not required;
determining vehicle speed, wherein if the vehicle speed is above a predetermined vehicle speed threshold, then the determination is that braking is other than not required; and
determining a throttle frequency, wherein if the throttle frequency is above a predetermined throttle frequency threshold, then the determination is that braking is other than not required.

17. The method of claim 16, wherein after said step of determining a rate of throttle down, further comprising the step of pre-charging the braking system if said step of determining determines that the brakes are not applied and that the rate of throttle down is above the predetermined throttle down threshold.

18. The method of claim 16, wherein in said step of determining, if said predetermined conditions comprise the brakes are not applied, the rate of throttle down is not above the predetermined throttle down threshold, the throttle position is not above the predetermined throttle position threshold, the vehicle speed is not above the predetermined vehicle speed threshold, and the throttle frequency is not above the predetermined throttle frequency threshold, then the determination is that braking is not required.

19. The method of claim 18, wherein in said step of determining: the throttle down threshold is in a range substantially around 450 degrees per second;
the throttle position threshold is in a range substantially around thirty percent; the vehicle speed threshold is in a range substantially around one hundred thirty kilometers per hour; and the throttle frequency threshold is in a range substantially around one throttle action per second over a ten second interval.

20. The method of claim 19, wherein after said step of determining a rate of throttle down, further comprising the step of pre-charging the braking system if said step of determining determines that the brakes are not applied and that the rate of throttle down is above the predetermined throttle down threshold.
